(19) United States
(12) Patent Application Publication
(10) Pub. No.: US 2020/0080375 A1
(43) Pub. Date: Mar. 12, 2020

(54) Gate-Operated Kinetic Energy Switches

(71) Applicants: John Joseph Girard, Lakewood, OH (US); Claus Munch Lendal, Avon Lake, OH (US)

(72) Inventors: John Joseph Girard, Lakewood, OH (US); Claus Munch Lendal, Avon Lake, OH (US)

(21) Appl. No.: 16/126,228

(22) Filed: Sep. 10, 2018

(51) Int. Cl. E06B 11/02; E05F 1/02; G08B 13/08; H01H 13/50

(52) U.S. Cl. CPC E06B 11/022; E05F 1/02; H01H 2239/076; H01H 13/50; E05Y 2900/40; G08B 13/08

(57) ABSTRACT

A gate is pivotally mounted on an upstanding post located adjacent a juncture of intersecting travel paths. To prevent collisions of persons and/or vehicles moving along the intersecting travel paths at the travel path juncture, a kinetic energy harvesting switch is carried by the upstanding post and has a spring-projected push button or plunger-type operator that is depressed relative to a housing of the switch when the gate begins to open to admit a person and/or a vehicle to the travel path juncture. Energy harvested by the switch is utilized to transmit a radio frequency signal that can be received by a device that displays a visual warning and/or emits an audible warning, advising that collision avoidance measures are likely to be needed to prevent a collision at the travel path juncture.

### REFERENCE TO RELATED APPLICATIONS

This utility application is a continuation-in-part of utility application Ser. No. 16/113,690 filed Aug. 27, 2018, entitled GATE SUPPORTIVE, SIGNAL TRANSMITTING HINGE, the disclosure of which is incorporated herein, in its entirety, by reference.

Utility application Ser. No. 16/113,690 claimed the benefit of the filing date of Provisional Application Ser. No. 62/606,580 filed Sep. 28, 2017, entitled GATE-OPERATED KINETIC ENERGY SWITCHES, the disclosure of which is also incorporated herein, in its entirety, by reference.

### BACKGROUND

In large industrial storage facilities, goods that have been manufactured and/or assembled, as well as components awaiting further manufacture or assembly, often are compactly loaded onto pallets that are temporarily stored either on vertically spaced shelves, or in open-front bins, that are defined by tall, upstanding storage structures which are arranged in parallel-extending rows atop large floor surface areas, as, for instance, in a warehouse.

The palletized goods and components referred to just above are located, when needed, and are then transported into, out of, and from place to place within large industrial storage facilities, by fork lift vehicles that move along substantially linear travel paths that form substantially perpendicular grids for vehicular traffic.

What are referred to as “primary travel paths” provide substantially linear routes of travel that extend from the large industrial storage facilities into nearby manufacturing and assembly areas, as well as into regions of a factory where trucks, railroad cars and/or other vehicles are loaded so that palletized items that have substantially completed at least some stages of production and/or assembly can be transferred to where a next stage of production will be undertaken, or to distributors that will offer completed goods for sale; or are off-loaded from trucks, railroad cars and the like to be loaded into the upstanding storage structures until these components are needed during manufacturing or assembly processes.

The primary travel paths also extend along end regions of the rows of the upstanding storage structures to provide routes that are followed by the fork lift vehicles when they need to transition between the spaced rows of the upstanding storage structures.

What are referred to as “secondary travel paths” define linear aisles between each adjacent pair of the upstanding, parallel-extending storage structures. The secondary travel paths intersect substantially perpendicularly with the primary travel paths at travel path junctures located at the ends of the adjacent pairs of the upstanding storage structures.

The shelves and open-front bins defined by each adjacent pair of the upstanding storage structures usually open toward the associated secondary travel paths that define aisles between each adjacent pair of upstanding storage structures. The fork lift vehicles that move palletized goods along each of the secondary travel paths also are used to load palletized goods onto, and off of, the shelves, as well as into and out of the open-front bins, that open toward the secondary travel paths which define aisles between the pairs of upstanding storage structures.

When fully loaded pallets are supported in bins or on shelves that are located near the end of a particular secondary travel path, these fully loaded pallets often block the ability of persons and vehicle drivers who are in the secondary travel path to see fork lift vehicles that are moving along adjacent primary travel paths that extend to the left and right of the particular secondary travel path.

Stated in another way, persons in a secondary travel path can be “blind” to fork lift vehicle traffic that is moving along an adjacent, perpendicularly extending primary travel path.

The aforementioned “blindness” to perpendicularly approaching vehicles, combined with an occasional tendency of at least some operators of fork lift vehicles to drive their vehicles to and through the junctures of primary and secondary travel paths at speeds that are somewhat greater than may allow for optimum safety, sometimes leads to collisions that occur as fork lift vehicles concurrently attempt to drive through the same perpendicular junctures of the primary and secondary travel paths.

Likewise, collisions tend to occur when an individual (who has been performing some needed function while standing or walking within one of the secondary travel paths) steps out from an end of the secondary travel path, into an adjacent primary travel path where unnoticed fork lift vehicles may be moving to the left or right of the secondary travel path while transporting palletized goods. If an individual who exits a secondary travel path does so without slowing to exercise caution (by checking to the left and to the right for approaching fork lift vehicles) before entering an adjacent primary travel path, the individual can be quite suddenly and unexpectedly impacted by a moving fork lift vehicle loaded with palletized goods.

These surprising “in-your-face” impacts can cause injuries that are severe.

Exacerbating the likelihood of occurrence of these injury-causing impacts is the previously explained “blindness” of secondary travel path individuals and fork lift vehicle drivers (to perpendicularly approaching primary travel path vehicles) caused by shelves and bins that carry fully loaded pallets that block the left and right vision of individuals and vehicle drivers who are about to exit a secondary travel path to enter an adjacent primary travel path.

A completely different topic of background information that is pertinent to the present invention relates to what are known as “kinetic energy switches.” These small yet remarkable devices (also known as “KES units”) typically have generally rectangular housings with lengths and widths that each measure less than two inches. A third dimension of the generally rectangular housings typically measures less than three-fourths of an inch.

Extending from opposite side walls of each KES unit housing are both a small, flexible antenna that is usually about six inches in length, and a short, spring-projected push button or plunger-type operator. When the push button or plunger-type operator of a KES unit is moved (i.e., is “operated,” either by being depressed toward or into (or by being permitted to extend outwardly from) the housing of the KES unit), the KES unit transmits a radio frequency signal through the antenna of the KES unit for a distance that often can reliably be received as far away as six hundred to a thousand feet, or more, from the KES unit.

An unusual and especially advantageous feature of each KES unit is that no battery or other external energy source needs to supply power to the KES unit in order for the push-button-operated unit to transmit the unit's unique radio signal. What this means is that each KES unit functions by “harvesting” the kinetic energy that is expended to depress or release the push button or plunger-type operator of the KES unit to cause the unit to emit its unique radio frequency signal.

Accordingly, installations of KES units are “wireless” because no connected wiring of any sort is required either to provide electric power, or to enable the KES units to transmit their radio frequency signals to remotely positioned signal receiving units. Because the radio frequency signals that are transmitted by the KES units are uniquely encoded, each remotely located receiving unit that responds to a particular radio frequency signal can be said to be “linked” to the KES unit that transmits the particular radio frequency signal.

In preferred practice, a radio signal receiver that responds to signals from a particular KES unit is either electrically connected to, or is an integral part of a warning device designed to be mounted in the ceiling of, or along a sidewall of a primary travel path that is located adjacent to the KES unit. Warning devices are preferably mounted at locations where a flashing light is caused to illuminate (or an audible alarm signal is caused to sound) from a particular warning device to give notice to fork lift vehicles approaching a particular travel path juncture that an individual and/or a fork lift vehicle is about to emerge from a secondary travel path into the primary travel path at an associated juncture of the travel paths.

These visual and/or audible warning notifications need not come from wall or ceiling mounted warning devices, but can also come from radio signal receiving units that are carried by fork lift vehicle drivers—or that can be mounted on the fork lift vehicles themselves. Such radio signal receiving units can identify the particular travel path juncture where an individual or a fork lift vehicle is expected to emerge from a secondary travel path into the primary travel path so fork lift vehicle drivers know immediately where a gate to a secondary travel path is being opened—so that neither the particular gate, nor the particular travel path juncture needs to be within the clear view of a fork lift vehicle driver.

U.S. patents that disclose a variety of forms of electro-mechanical energy harvesting switches include U.S. Pat. No. 9,552,937 issued Jan. 24, 2017 to Erdmann et al; U.S. Pat. No. 7,019,241 issued Mar. 28, 2006 to Grassi et al; U.S. Pat. No. 6,933,655 issued Aug. 23, 2005 to Morrison et al; and U.S. Pat. No. 6,700,310 issued Mar. 2, 2004 to Maue et al. The disclosures of these patents are incorporated herein by reference.

Yet another different topic of background information is disclosed in the referenced utility application from which the present application is filed as a continuation-in-part, namely application Ser. No. 14/113,690 filed Aug. 27, 2018, entitled GATE SUPPORTIVE, SIGNAL TRANSMITTING HINGE, which discloses a two-part hinge that 1) has a first hinge component that has a generally cylindrical passage into which a generally cylindrical formation of a second hinge component depends whereby the second hinge component is pivotally supported by the first hinge component, and 2) has the first hinge component configured to carry a housing of an energy harvesting switch, and with a second hinge component configured to move an operator (typically a push button or a plunger) of the energy harvesting switch in response to relative pivotal movement of the first and second hinge components.

As the referenced utility application explains, and as is illustrated in FIGS. 18 and 19 of the present application, the first and second components of the hinge can be used to pivotally mount a closure such as a gate or other pivotal barrier, with the hinge also being capable of operating an energy harvesting switch carried by the first hinge component, so that relative pivotal movement of the two components of the hinge (caused, for example, by opening movement of closure, gate or other form of pivotally mounted barrier) will cause the energy harvesting switch to transmit a radio frequency signal that can trigger the operation of an audible and/or visual warning device.

### SUMMARY OF THE INVENTION

This is a safety-related invention. One aspect of the present invention relates to a movable barrier (such as a gate or other pivotally mounted closure that is preferably biased toward a closed orientation) for slowing the exit of an individual or a fork lift vehicle or the like from a secondary travel path into a juncture with a transversely extending primary travel path to minimize or obviate the possibility of the exiting individual or fork lift vehicle being impacted by vehicles traveling along the primary travel path.

One feature of the present invention is the fact that it can be advantageously used to minimize or obviate the impacts of persons and/or vehicles at junctures of travel paths by causing warning signals to be wirelessly transmitted to audible and/or visual warning devices when persons or vehicles are about to enter a travel path junction through which forklift vehicles and the like may be moving—so the operators of vehicles traveling along intersecting travel paths can take appropriate action to avoid collisions at travel path junctures.

The present invention preferably uses short, upstanding, post and gate assemblies to perform a number of safety-related functions that include deliberately slowing the process of persons and/or vehicles exiting from a secondary travel path into a primary travel path, so that a more cautious transition is made from the secondary travel path into the juncture with the primary travel path.

As will also become apparent, the present invention utilizes short, upstanding, post and gate assemblies to position KES units for wirelessly transmitting radio frequency signals that cause warning notifications to be provided to drivers of fork lift vehicles that are moving along a primary travel path that a person or vehicle is about to enter from a secondary travel path, at a nearby juncture of the primary and secondary travel paths.

Viewed in another way, the present invention combines the compact configuration and wireless operational characteristics of kinetic energy switches (aka, “KES units”) with the relatively low cost advantages of simple, easy-to-install, post and gate assemblies to accomplish safety-related objectives that help to minimize and prevent such fork lift vehicle and personnel impacts and collisions as have come to occur with increasing frequency during recent years at the junctures of primary and secondary travel paths in large industrial storage facilities.

Although FIGS. 9 and 10 of the accompanying drawings depict the use of post-mounted half-length gates that are normally biased toward “closed” orientations that extend across the end regions of secondary travel paths, in accordance with preferred practice, post-mounted full-length gates are used (such as is shown in FIGS. 5-8 and 11), with each of the gates being biased toward a “closed” orientation that extends perpendicularly across the end region of an associated secondary travel path.

The manner in which gates are biased toward their closed orientations is a matter of choice inasmuch as a variety of biasing techniques are familiar to those who are skilled in the art. Torsion spring biasing is one compact way of accomplishing such biasing, with coils of a torsion spring encircling a pivot pin axis about which each gate swings relative to its supporting post.

Another biasing technique well known to those who are skilled in the art is “gravity biasing” that causes each gate to lift slightly as it pivots progressively away from its closed orientation—which utilizes the weight of each gate to bias the gate back toward its closed orientation. Interactive cams (that provide a spiral incline that each gate is required to climb as the gate pivots toward an “open” orientation) permits the weight of each gate to pivot the gate back toward its “closed” orientation when the gate is no longer being held in an open orientation.

Although the post-mounted gate assemblies are intended to temporarily obstruct and therefore to slow the exit of personnel and vehicles from secondary travel paths into adjacent primary travel paths, the gates are not normally intended to prevent the exit of personnel and vehicles from the secondary travel paths. However, in special circumstances (for example, when urgent work is underway along a particular travel path), the gate(s) that control access to the particular travel path can be locked or otherwise held in place used to prevent passage into and out of the particular travel path until the urgent work along the travel path has been completed.

Each post and gate assembly is provided with a KES unit designed to transmit its uniquely encoded radio signal when the gate of the assembly begins to pivot from its normally closed orientation toward an open orientation. An appropriately positioned warning device is operated by a radio frequency signal receiving device that responds to the radio frequency signal transmitted from an associated KES unit, and thereby provides a warning to any fork lift vehicles that are approaching a travel path juncture where the radio signal originated. By this arrangement, fork lift vehicle drivers moving along a primary travel path are warned of the likely entry of a person or vehicle at the location of a particular travel path juncture, so suitable action can be taken to prevent collisions and injury-causing impacts.

Each post-mounted gate assembly preferably has a KES unit with a housing that is fastened to the post of the assembly, and has a spring projected push button that is movable toward and away from (i.e., into and out of) the housing. A cam that turns with the gate of the post-mounted gate assembly presses on the push button when the gate opens. When the cam depresses the spring-projected push button, or when the cam permits the push button to extend relative to the housing, the movement of the push button is “energy harvested” by the KES unit to cause wireless transmission of a radio signal to a radio signal receiving unit that actuates a warning device such as a flashing light or an audible alarm.

If a warning device such as a flashing light or an audible alarm (typically mounted adjacent or above an intersection where an accident is likely to occur because a person or a fork lift vehicle is about to emerge into the primary travel path), the drivers of fork lift vehicles that are approaching the particular travel path juncture know at once where an individual or a fork lift vehicle is likely to emerge in front of the person or vehicle.

A cam that is turned by an associated gate preferably has a flat region that interrupts an otherwise round or circular perimeter of the cam. When the round or circular perimeter engages the push button or plunger-type operator a KES unit, the push button is depressed. However, when the flat region of the cam is engaged by the push button or plunger-type operator, the spring projected push button or plunger-type operator is permitted to extend relative to the housing of the KES unit.

Either of the two aforementioned movements of the push button or plunger-type operator of a KES unit exerts kinetic energy that is “harvested” by the KES unit to generate sufficient electrical energy to cause emission of the radio signal that is received by a remotely positioned radio signal receiver that, in turn, causes an associated warning signal device to apprise fork lift vehicle drivers traveling along an associated primary travel path that an individual, or another fork lift vehicle, is about to enter the primary travel path at a nearby secondary travel path juncture—hence appropriate slowing and/or other collision avoidance action is likely to be needed.

As those who are skilled in the art will readily appreciate, the pivotally mounted gates can have their pivotal movement restricted to permit pivotal gate movement in only one direction when the gate opens. This restricted opening movement can, for example, be utilized to prevent pivotal movement of a gate into a primary travel path so the gates, themselves, are less likely to be impacted by fork lift vehicles moving through travel path junctures adjacent the gates.

### BRIEF DESCRIPTION OF THE DRAWINGS

These, and other features, advantages and objectives of the invention will become apparent from the description and preliminary claims that follow, taken together with the accompanying drawings, wherein:

FIG. 1 is a top, right and front perspective view of a commercially available kinetic energy switch, also known as a “KES unit,” with a spring-projected push button or plunger-type operator of the KES unit being extended relative to a housing of the KES unit;

FIG. 2 is a top plan view of the KES unit positioned near a generally annular rotatable cam having a flat surface defined by a portion of the otherwise round perimeter of the cam, with the cam turned to an orientation that permits the spring-projected push button or plunger-type operator of the KES unit to be extended relative to the housing of the KES unit;

FIG. 3 is a top plan view of the KES unit and the rotatable cam, with an arrow indicating how the cam can be turned to cause the round portion of the cam's perimeter to cause the push button or plunger-type operator of the KES unit to be depressed relative to the housing of the KES unit;

FIG. 4 is an exploded perspective view showing, on an enlarged scale, top and bottom portions of a housing that, when assembled, protectively encloses the cam and the KES unit that are shown in FIGS. 2 and 3, and that permits the cam to turn relative to the KES unit concurrently with the associated gate, as the cam depresses or permits the spring-projected push button or plunger-type operator of the KES unit to extend relative to the housing of the KES unit, with the top and bottom portions of the housing having aligned passages formed therefrom that permit a pivot pin (shown in FIG. 5) to extend therefrom to drivingly connect with the cam;

FIG. 5 is an exploded perspective view of an upstanding post and gate assembly that permits the gate to pivot about a vertical axis of the aforementioned pivot pin which extends through aligned passages defined by the post and gate, so the gate can pivot relative to the post about the axis of the pivot pin (which is shown foreshortened), it being understood that the pivot pin is drivingly connected to the gate to turn concurrently therewith about the axis of the pivot pin;

FIG. 6 is a schematic top plan view showing a large industrial storage area extending to the right of an upstanding factory wall, with five rows of upstanding storage structures shown extending perpendicular to the factory wall at a distance separated from the factory wall by a primary travel path that extends along the inside of the factory wall, with secondary travel paths providing aisles that separate adjacent pairs of the upstanding storage structures, with the upstanding storage structures defining side-by-side bins that open toward the associated secondary travel paths or aisles, and with post and gate assemblies being positioned adjacent the junctures of the primary and secondary travel paths;

FIG. 7 shows a selected portion of the schematic top view of FIG. 6, with one fork lift vehicle shown moving a pallet along the depicted primary travel path, with another fork lift vehicle shown moving another pallet along the depicted secondary travel path, and with both of the fork lift vehicles approaching a juncture of the primary and secondary travel paths that has a gate shown in its normal closed orientation;

FIG. 8 is a schematic top view nearly identical to FIG. 7 except that the fork lift vehicle in the secondary travel path is shown with its pallet in contact with, and beginning to open, the depicted gate structure;

FIG. 9 is a schematic top view nearly identical to FIGS. 7 and 8 except that the fork lift vehicle shown exiting the secondary travel path has its pallet in contact with, and beginning to open, a depicted pair of relatively short, oppositely pivoting gate structures;

FIG. 10 is a schematic top view nearly identical to FIG. 9 except that the depicted relatively short gate structures are being opened by a pallet that is being moved into the secondary travel path by a fork lift vehicle that is about to enter the depicted secondary travel path;

FIG. 11 is a schematic top view nearly identical to FIG. 8 except that the depicted full length gate is being pulled toward an open orientation (extending into the depicted secondary travel path) by an individual “I” who is about to exit from an end region of the secondary travel path;

FIG. 12 is an exploded perspective view copied from a utility application referenced above (from which the present utility application is continuation-in-part) showing first and second components of a hinge that can be used in the practice of the present invention, including an energy harvesting switch or “KES unit” such as is shown in FIG. 1 hereof, that has a spring-projected push button or plunger type of “operator” that extends from one end region of the housing of the KES unit, and a flexible antenna that extends from an opposite end region of the housing for transmitting a radio frequency signal in response to the push button or plunger-type operator being depressed toward and into the housing of the energy harvesting switch or KES unit;

FIG. 13 is a perspective view showing the first and second hinge components assembled, with a generally cylindrical, substantially vertically extending passage of the first hinge component receiving a generally cylindrical formation of the second hinge component that depends into the generally cylindrical passage, with the energy harvesting switch extending into and being carried within a generally rectangular passage that is also defined by the first hinge component;

FIG. 14 is a front view of the assembled components that are shown in FIG. 13;

FIG. 15 is a cross-sectional view of the assembled hinge components, as seen substantially from a plane indicated by a line 15-15 in FIG. 14;

FIG. 16 is a cross-sectional view of the assembled hinge components as seen substantially from a plane indicated by a line 16-16 in FIG. 15;

FIG. 17 is a cross-sectional view similar to FIG. 15, but with one of the two hinge components turned approximately ninety degrees relative to other of the two hinge components as depicted in FIG. 15;

FIG. 18 is a top view of the assembled hinge components, with one of the two hinge components connected to a gate, and with the other hinge component connected to an upstanding support; and

FIG. 19 is a top view similar to FIG. 18 but with one of the hinge components (and the attached gate) turned approximately ninety degrees relative to the orientation of the other hinge component as depicted in FIG. 18.

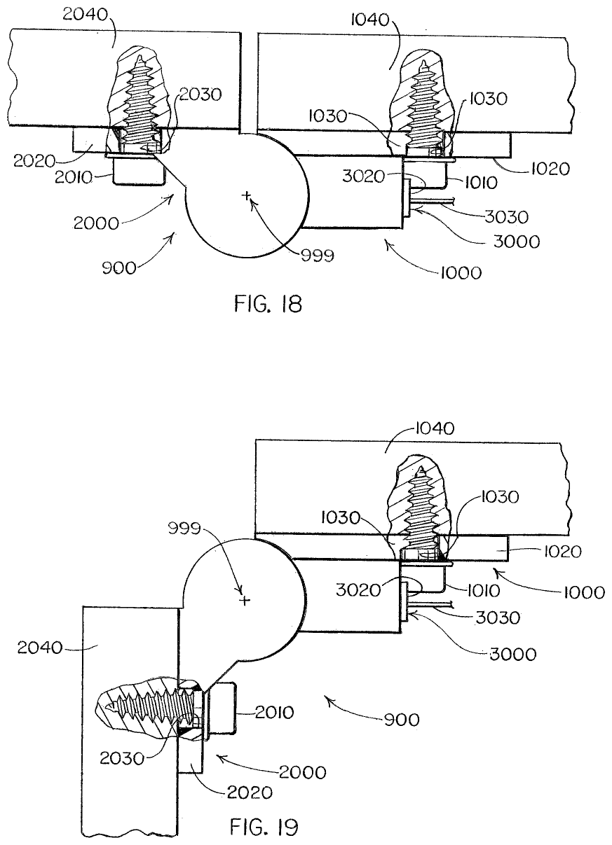

In FIGS. 18 and 19, portions of a wooden gate, a wooden support, and two plastic hinge components are broken away and shown in cross-section to permit wood screws to be seen that fasten the plastic hinge components to the wooden gate and to the wooden support.

### DETAILED DESCRIPTION

As has been explained, in preferred practice the present invention relates to the provision and use of post and gate assemblies, each of which includes an upstanding floor mountable post installed adjacent a separate one of the several perpendicular travel path junctures defined by a grid of travel paths followed by fork lift vehicles as they move along and among a set of upstanding storage structures in a large, industrial storage area where palletized goods are temporarily held on pallets until the goods are needed elsewhere.

As also has been explained, in preferred practice, the floor-mountable post and gate assemblies of the present invention each include a post component and a gate component that are pivotally connected, together with a kinetic energy switch that is operated by a cam interposed between the post and gate components to send uniquely encoded radio signals to remotely located receiving units that operate warning devices to notify drivers of fork lift vehicles moving along (by way of an example) a primary travel path that an individual or another fork lift vehicle is about to enter at a juncture of the primary travel path with a secondary travel path.

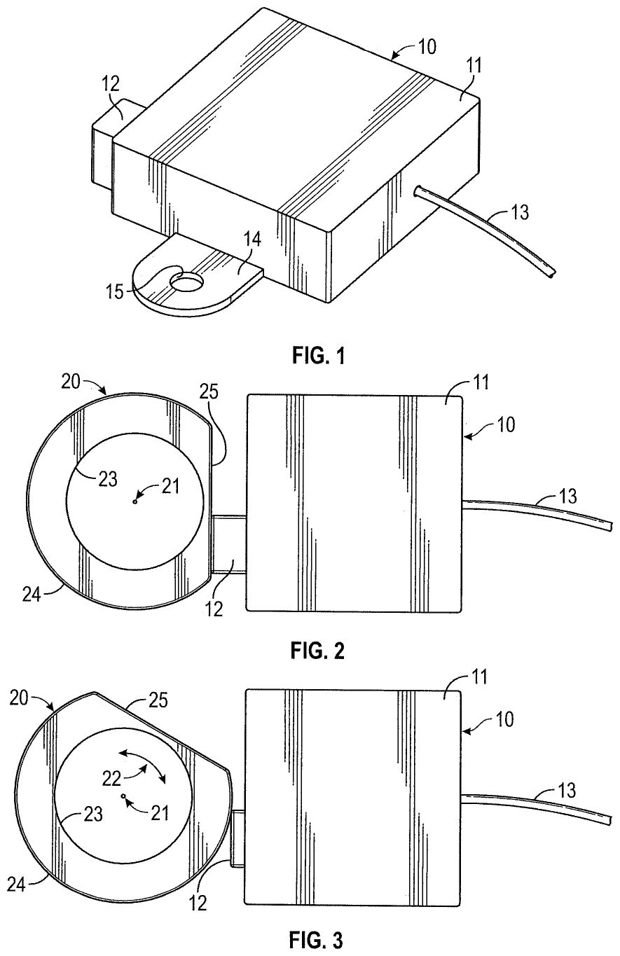

With the foregoing in mind, FIGS. 1-3 show a commercially available energy harvesting signal generating device known as a kinetic energy switch (or so-called KES unit) that is indicated generally by the numeral 10. The KES unit 10 has a generally rectangular housing assembly 11 with a length and width that each typically measures slightly less than two inches. A third dimension of the housing assembly 11 is a housing thickness that is typically slightly less than three-fourths of an inch.

As can be seen in each of FIGS. 1-4, extending from opposite sides of the housing 11 are a push button or plunger-type operator 12, and a flexible, small diameter antenna 13 (that is usually about three to about six inches in length, but is shown only partially in FIGS. 1-4). An optional mounting tab 14 (see the embodiment shown in FIGS. 1 and 4) extends from another side wall of the housing 11, and is provided with a hole 15 that can be used to receive a fastener (not shown) for connecting the KES unit 10 to the housing 11, or to other support structure (not shown).

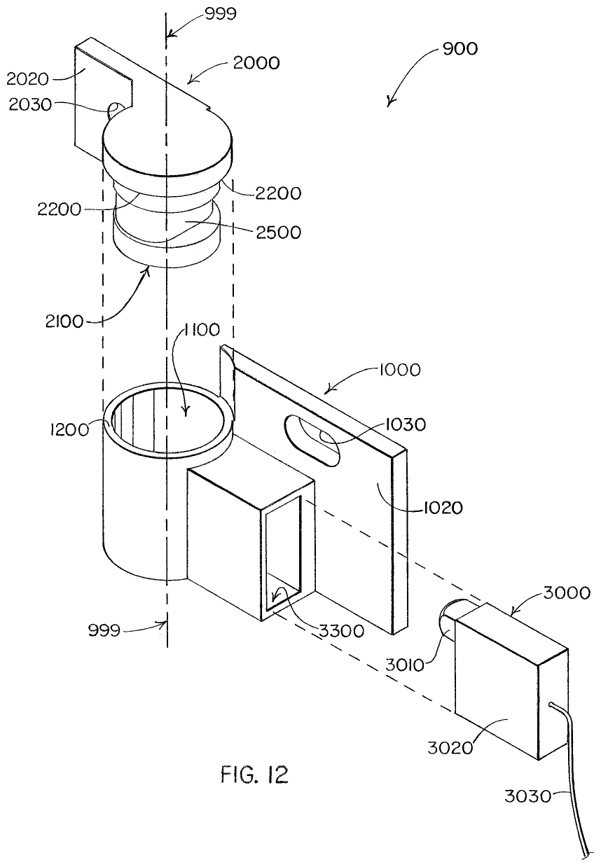

A slightly simpler form of the same energy harvesting switch 10 is indicated by the numeral 3000 in FIG. 12, where the housing of the switch 3000 is indicated by the numeral 3020, a push-button type operator of the switch 3000 is indicated by the numeral 3010, and a short flexible antenna of the switch 3000 is indicated by the numeral 3030. The switch 3000 differs from the switch 10 shown in FIG. 1 only in that the housing 3020 has no mounting tab 14 such as is shown in FIG. 1.

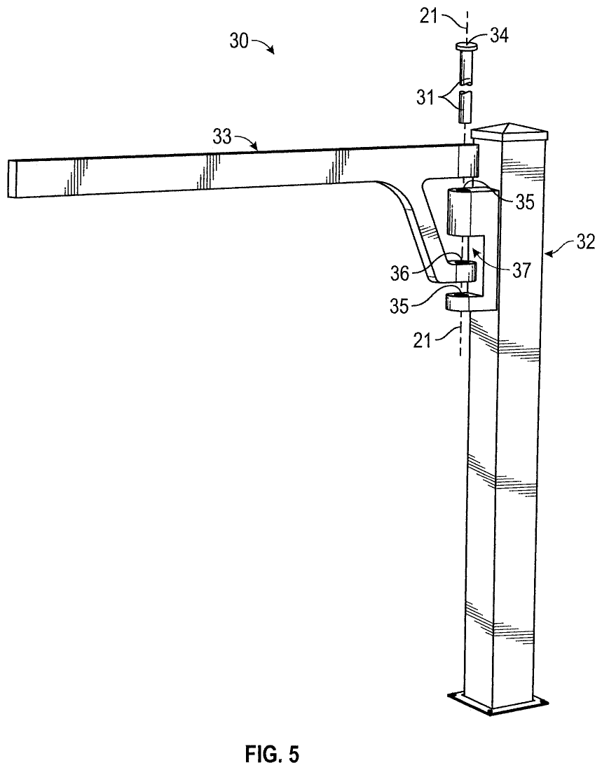

As will be explained shortly, a generally annular cam 20 that is shown in FIGS. 2-4 is provided to operate the kinetic energy switch (or KES unit) 10 in response to turning of the gate 33 of a post and gate assembly 30 that is shown in FIG. 5. When the gate 33 pivots about a pivot axis 21 (shown in FIGS. 2-5), the cam 20 also pivots about the axis 21, which causes the push button 12 of the KES unit to be operated, thereby causing the KES unit 10 to transmit a uniquely encoded radio frequency signal via the antenna 13.

The KES unit 10 is commercially available from distributors of electrical and electronic products that sell products bearing the registered trademark CHERRY, as a so-called “energy harvesting wireless switch,” manufacturer's part number AFIS-5002. The KES units 10 are currently being offered for sale by ZF Electronics, a German corporation.

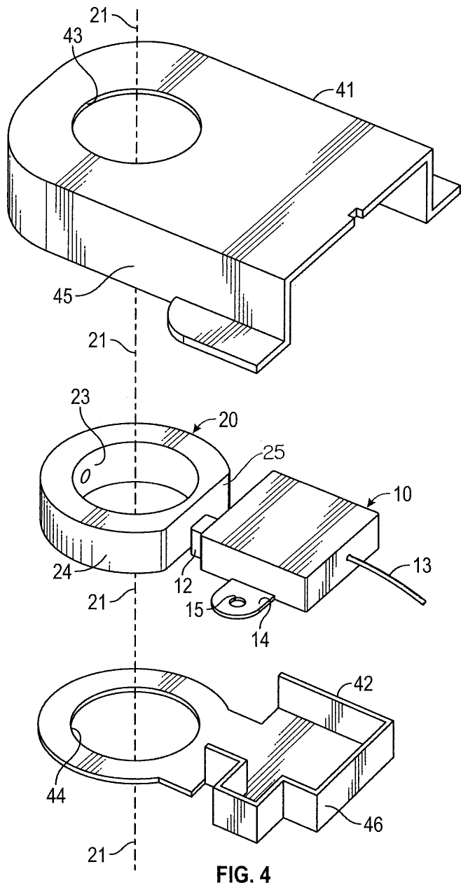

Referring to FIGS. 2 and 3, the KES unit 10 is shown positioned quite near to the generally annular cam 20. The cam 20 has an inner diameter 23 that extends concentrically about the pivot axis 21. A perimeter 24 of the cam 20 is round and is concentric about the pivot axis 21 except where a flat surface 25 is defined by limited portion of the perimeter 24.

The inner diameter 23 of the cam 20 is preferably sized to snugly receive (and to be drivingly connected to) an elongate stem of a pivot pin 34 (shown in FIG. 5) that pivotally connects the gate 33 to an upstanding post 32 of the post and gate assembly 30 that is shown in FIG. 5. The pivot pin 34 turns about the axis 21 together with the gate 33 relative to the post 32—which means that the cam 20 also turns about the pivot axis 21 with the gate 33.

Referring to FIG. 4, top and bottom components 41 and 42, respectively, of the housing assembly 11, are depicted that, when assembled by being snapped together, are configured to protectively enclose the KES unit 10 and the cam 20.

Aligned openings 43, 44 are defined by the top and bottom housing components 41, 42, respectively, of the housing assembly 11 and extend concentrically about the pivot axis 21. The openings 43, 44 are of equal diameter, and are sized to permit the pivot pin 34 to extend loosely therethrough, so the pivot pin 34 can turn freely about the pivot axis 21 relative to the housing assembly that is defined by the snap-together top and bottom housing components 41, 42.

The top housing component 41 is configured to overlie the KES unit 10 and the cam 20, and to receive much of the bottom housing component 42 within a chamber defined by the top housing component 41. The top housing component 41 has a depending sidewall 45 that encircles much of the cam 20 and extends along opposite sides of the KES unit 10. The bottom housing component 42 is configured to underlie the KES unit 10 and the cam 20, and has an upstanding sidewall 46 configured to cooperate with the top housing component 41 in protectively enclosing the KES unit 10.

Referring to FIG. 5, the components of a post and gate structure assembly 30 are shown that include an upstanding, floor-mountable post (or post structure) 32 that pivotally supports a gate (or gate structure) 33 to swing about the pivot axis 21 of the pivot pin 31. The pivot pin 31 has an enlarged head 34 at its upper end, from which a uniform diameter stem of the pivot pin 31 depends in a slip fit extending through aligned holes 35, 36 defined by the post structure 32 and the gate structure 33, respectively.

In FIG. 5, at a location indicated generally by an arrow 37, one or more of the housing assemblies 11 that are formed by the pair of the snap-together top and bottom housing components 41, 42 can be supported by the depicted upstanding post 32, with the cam 20 inside each such housing being drivingly connected to the pivot pin 31 that extends through the cam 20 to thereby be turned about the axis 21 as the gate 33 turns about the axis 21. The turning of the cam 20 within each such housing operates the associated KES unit 10 by causing the push button 12 to be moved relative to the body of the KES unit that is protectively housed by the snap-together top and bottom housing components 41, 42 of each such housing assemblies 11, shown in FIG. 4.

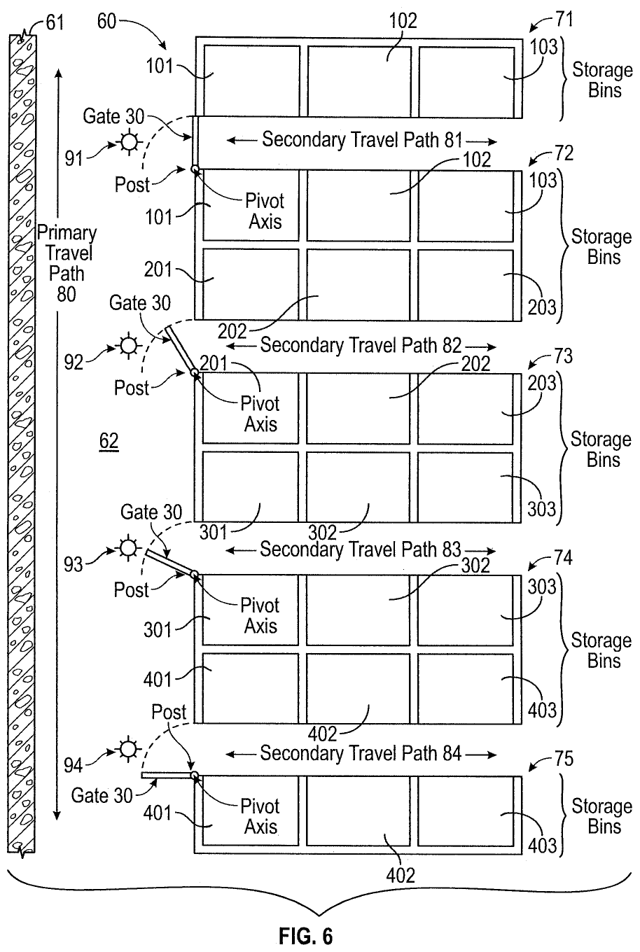

Referring to FIG. 6, a typical large industrial storage area is indicated generally by a numeral 60 that is bordered along its left side by a factory wall 61. Five upstanding storage structures 71, 72, 73, 74 and 75 are shown positioned atop a large floor area 62.

Referring to FIG. 6, the primary travel path 80 extends alongside the interior of the factory wall 61, and along end regions of the upstanding storage structures 71, 72, 73, 74 and 75. The secondary travel paths 81, 82, 83 and 84 define aisles that extend between adjacent pairs of the upstanding storage structures 71, 72, 73, 74 and 75.

In FIG. 6, the upstanding storage structures 71, 72, 73, 74, 75 are shown, each defining a plurality of open-front bins that are configured to receive and temporarily support and store palletized goods that are positioned in the bins, or on the shelves (not shown).

Portions of the upstanding bin structures 71 and 72 have bins 101, 102, 103 that open toward the secondary travel path (or aisle) 81. Portions of the upstanding bin structures 72 and 73 have bins 201, 202, 203 that open toward the secondary travel path (or aisle) 82. Portions of the upstanding bin structures 73 and 74 have bins 301, 302, 303 that open toward the secondary travel path (or aisle) 83. Portions of the upstanding bin structures 74 and 75 have bins 401, 402, 403 that open toward the secondary travel path (or aisle) 84.

Fork lift vehicles of various descriptions are used to move pallets containing palletized goods into, and to withdraw palletized goods from the open-front bins (identified just above) as well as to move the palletized goods through the storage area 60 and among the storage structures 71, 72, 73, 74, 75 along the grid of travel paths that include a primary travel path 80, and secondary travel paths 81, 82, 83 and 84.

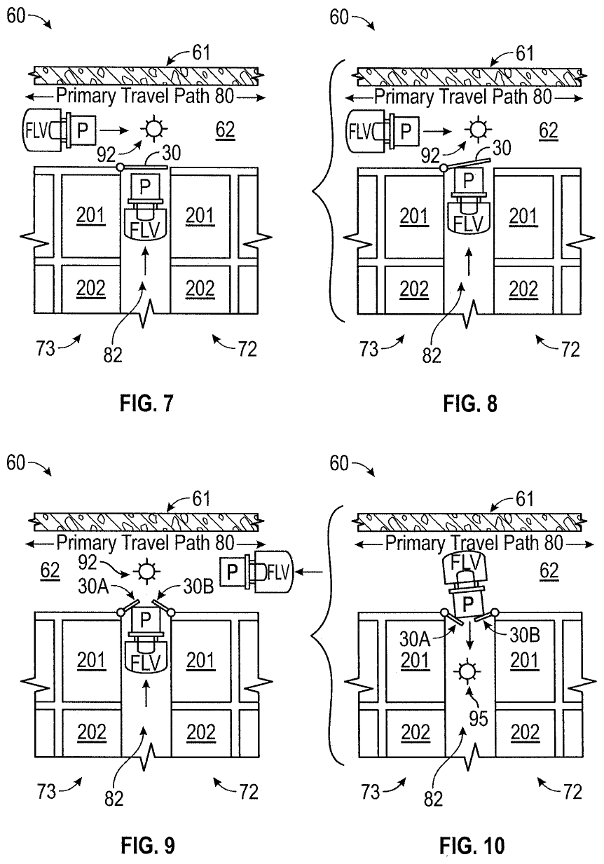

In each of FIGS. 6-11, fork lift vehicles are shown, designated by the letters “FLV,” with each fork lift vehicle FLV being shown supporting a pallet that is designated by the letter “P.” In FIGS. 7-9, one of the two depicted fork lift vehicles FLV is shown moving along the depicted primary travel path 80, and the other fork lift vehicle FLV is shown moving along the depicted secondary travel path 82.

In FIGS. 7 and 8, full length gates 30 are shown at the depicted junctures of the primary and secondary travel paths 80, 82.

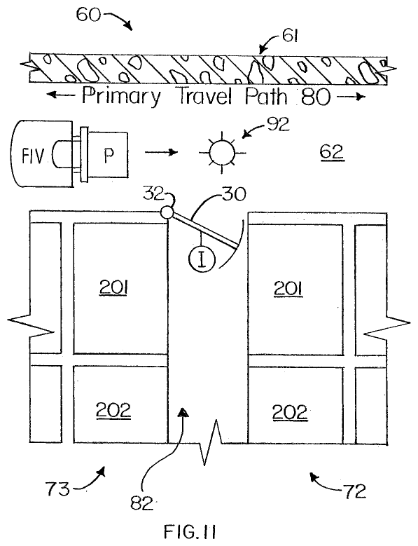

In FIG. 9, a fork lift vehicle FLV that is about to exit the depicted secondary travel path is shown concurrently pivoting a pair of half-length gates 30A and 30B. Half-length gates 30A and 30B are also shown in FIG. 10 where the one depicted fork lift vehicle FLV is shown exiting the depicted primary travel path 80, and entering the depicted secondary travel path 82, with the depicted gates 30A and 30B being pivoted oppositely from what is shown in FIG. 9.

In FIG. 6, four gate and post assemblies 30 (of the type shown in FIG. 5) can be seen to be floor-mounted adjacent the four perpendicular junctures of the primary travel path 80 with the secondary travel paths 81, 82, 83 and 84. A first one of the gate and post structure assemblies 30 located at the left end of the secondary travel path 81 is shown in its normal closed orientation, to which the gate structure 33 is preferably biased by one or more springs (not shown) or by cams that raise the gate (FIG. 5) slightly as the gate 33 pivots away from its closed orientation, whereby the weight of the gate 33 biases the gate (due to gravity, in a manner well known to those who are skilled in the art) back toward the gate's normally closed orientation.

In FIG. 6, a second one of the gate and post assemblies 30 is floor-mounted at the left end of the secondary travel path 82, and is shown beginning to move away from its normal closed orientation toward an open orientation. A third one of the gate and post assemblies is floor-mounted at the left end of the secondary travel path 83, and is shown pivoted to a more completely open orientation. A fourth one of the gate and post assemblies 30 is floor-mounted at the left end of the secondary travel path 84, and is shown pivoted to an even more completely open orientation.

Also shown in FIG. 6 are warning devices 91, 92, 93 and 94 that are positioned in a ceiling that overlies the primary travel path 80 near the left ends of the secondary travel paths 81, 82, 83 and 84, respectively. The warning devices 91, 92, 93 and 94 will be understood to include radio signal receivers that receive and respond to unique radio signals generated by pivotal movements of the gate and post structures 30 located adjacent the end regions of the secondary travel paths 81, 82, 83 and 84, respectively.

As the foregoing description has explained, the the present invention combines the wireless operational characteristics of KES units with the simplicity of pivotal gate and post assemblies to provide simple yet effective signal emitting devices that can be installed at relatively low cost adjacent the junctures of primary and secondary travel paths in large storage facilities to slow the speed of individuals and fork lift vehicles that are attempting to move through associated the perpendicular travel path junctures to help prevent collisions and impacts—most especially injury-causing impacts of individuals with fork lift vehicles and/or pallets carried by fork lift vehicles that are moving along primary travel paths.

As has also been explained, the present invention provides a method of utilizing both 1) relatively low cost of KES signal transmitting units that are interposed between pivotal gates and upstanding posts, and 2) the relatively unobtrusive configuration of short, floor-mounted posts on which gates are pivotally mounted, to provide easy-to-install signal-generating devices (namely KES units) that occupy a minimum of space without necessitating the costly installation of wires that connect to the signal generating devices to provide power and/or to carry signals to warning devices.

In accordance with the preferred practice of the invention, no fork lift vehicle can exit from a secondary travel path to begin entering the associated primary travel path without causing the associated gate to begin pivoting away from its closed or blocking orientation, toward an open orientation of the gate—so that a radio frequency signal is immediately transmitted to a receiving unit that, in turn, causes a warning device to provide an indication to vehicle drivers moving along an adjacent primary travel path of the need to promptly take action to avoid collisions and impacts.

FIG. 11 depicts an individual “I” standing within a secondary travel path 82 and is pulling on a full-length gate 33 to pivot the gate 33 inwardly into the secondary travel path 82, so the individual I can exit the secondary travel path 82.

The gate 33 depicted in FIG. 11 has its range of pivotal movement limited to a only a quarter turn from a closed orientation (paralleling the length of the primary travel path 80) where the gate 33 extends across and obstructs movement into and out of the secondary travel 82, to an open orientation (paralleling the length of the secondary travel path 82) where the gate 33 opens the juncture between the primary and secondary travel paths 80, 82, respectively.

By limiting the pivotal movement of the gate 30 depicted in FIG. 11 to only the quarter-turn just described, the gate 33 cannot pivot into the primary travel path 80, and therefore cannot collide with or impact a fork lift vehicle FLV that is moving along the primary travel path 80. By permitting the gate 30 to pivot into the secondary travel path 82, a fork lift vehicle FLV that needs to pivot into the secondary travel path is not obstructed by the gate 30 even when the gate 30 is in its closed orientation, for the FLV can simply push the gate 30 toward its open orientation.

By requiring an individual “I” who wants to exit the secondary travel path 82 to pull the gate 30 inwardly, this has the desired effect of slowing the exit of the individual “I” until such time as the gate 30 has been pivoted sufficiently inwardly into the secondary travel path 82 so the individual “I” can move around the wide-swinging end region of the gate 30—which will help the person to slow his exit from the secondary travel path 82, so that the individual “I” is more likely to see any approaching vehicles that are coming from the left or right along the primary travel path 80.

The following information is copied from the utility application referenced above which discloses and claims a two-part hinge that is particularly well suited to be used in the practice of the present invention.

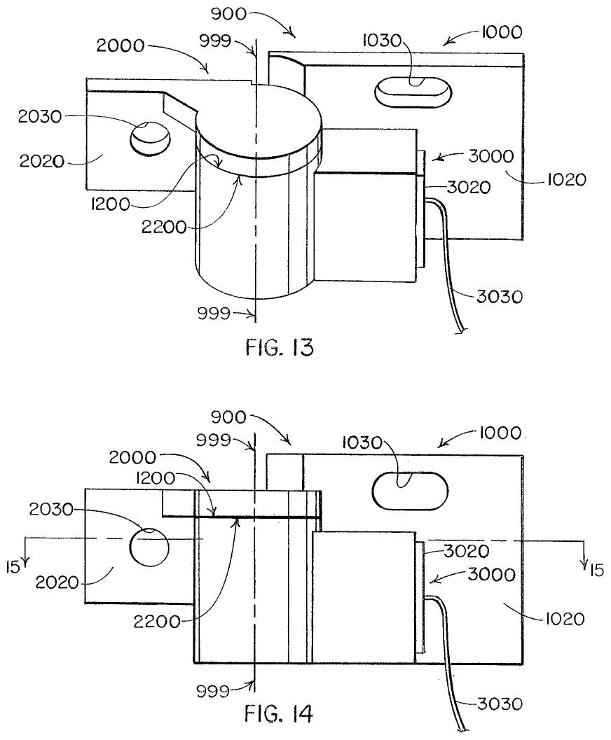

Referring to FIG. 12, a two-part hinge 900 has a first hinge component 1000 and a second hinge component 2000 that can pivot relative to each other about a hinge axis 999 when the two hinge components 1000 and 2000 are assembled in the manner shown in FIG. 13.

As can be seen in FIG. 12, the first hinge component 1000 defines a substantially vertically extending, generally cylindrical passage 1100 into which a substantially vertically extending, generally cylindrical formation 2100 of the second hinge component depends when the first and second hinge components 1000 and 2000 are assembled in the manner shown in FIG. 13.

As can also be seen in FIG. 12 the first hinge component 1000 has a substantially flat, upwardly-facing surface 1200 defined by the upper end region of the vertically extending passage 1100. When the first and second components 1000, 2000 of the hinge 900 are assembled as is depicted in FIG. 13, the substantially flat upper surface 1200 of the first hinge component 1000 is engaged by a downwardly-facing annular surface 2200 of the second hinge component 2000. The flat surfaces 1200, 2200 extend in a horizontal plane—which is to say that the flat surfaces 1200, 2200 extend substantially perpendicular to the substantially vertically extending hinge axis 999.

As can additionally be seen in FIG. 12, the first and second hinge components 1000, 2000 have elongate formations 1020, 2020 that extend rightwardly and leftwardly, respectively, from the vertically extending hinge axis 999. The elongate formations 1020, 2020 have openings 1030, 2030 formed therethrough, respectively, that can permit portions of such threaded fasteners 1010, 2010 as are shown in FIGS. 18 and 19 to extend therethrough to fasten the first and second hinge components 1000, 2000 to an upstanding support 1040, and to a preferably relatively lightweight gate 2040, respectively, portions of which are also shown in FIGS. 18 and 19.

As will become apparent by comparing the positions of the gate 2200 as shown in FIGS. 18 and 19, the gate 2200 can be pivoted about the substantially vertically extending hinge axis 999 through a range angular movement of at least about ninety degrees from a closed orientation depicted in FIG. 18, to an open orientation of the gate 2200 as depicted in FIG. 19.

The engagement of the substantially flat surfaces 1200, 2200 of the first and second hinge components 1000, 2000, respectively, not only limits how far the generally cylindrical formation 2100 can depend into the generally cylindrical passage 1100, but also serves to transfer the weight of the second hinge component 2000 to the first hinge component 1000. The engagement of the flat surfaces 1200, 2200 can also transfer at least some of the weight of a gate 2040 (that may be fastened to the second hinge component 2000 as shown in FIGS. 18 and 19) to the upstanding support 1040 (that may be fastened to the first hinge component 1000, as is also shown in FIGS. 18 and 19).

As was explained previously in conjunction with FIG. 1, the numeral 3000 in FIG. 12 indicates a commercially available so-called “energy harvesting switch” or so-called “KES unit” such as has been available for more than a year from an entity known as CHERRY SWITCHES (also known as CHERRY ENERGY HARVESTING SOLUTIONS) which is understood to have been purchased by the German corporation ZF Electronic Systems of Pleasant Prairie, Wis. 53158. The particular type of energy harvesting switch 3000 depicted in the drawings hereof is Model AFIS-5002 sold by CHERRY SWITCHES, which transmits a radio frequency signal at approximately 915 MHz when a spring-projected plunger-type operator 3010 of the switch 3000 is depressed into or is otherwise moved relatively toward a housing 3020 of the switch 3000.

As can best be seen in FIG. 12, the push button or plunger-type operator 3010 of the energy harvesting switch 3000 extends from one end region of the housing 3020, and a flexible antenna 3030 extends from an opposite end region of the housing 3020.

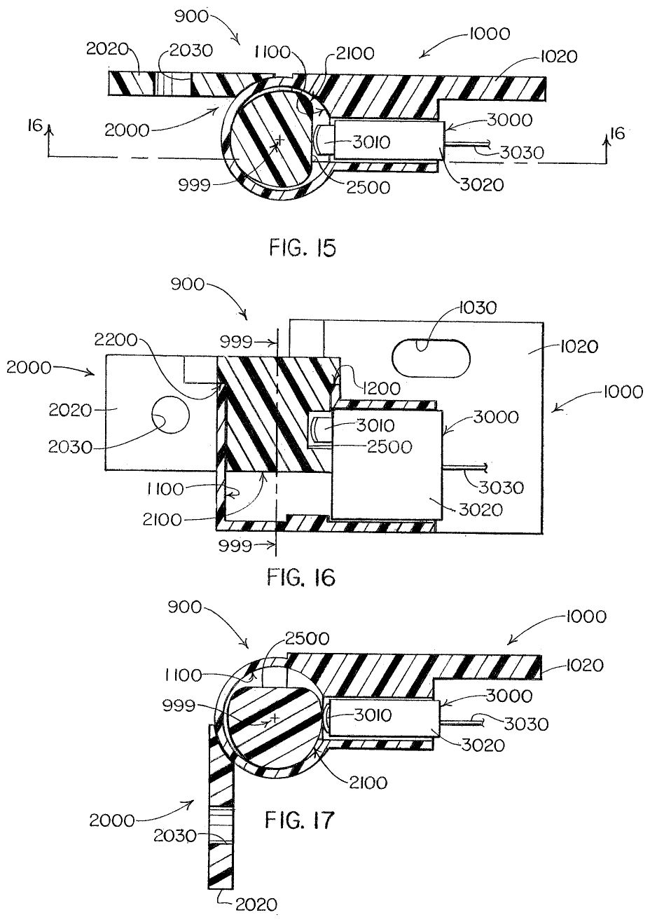

As can best be seen in FIGS. 15 and 16, the push button or spring-projected plunger-type operator 3010 of the energy harvesting switch 3000 normally extends about a quarter of an inch from the housing 3020. However, when the first and second hinge components 1000, 2000 are turned from the normally closed orientation shown in FIGS. 15, 16 and 18 to the normally open orientation shown in FIGS. 17 and 19, the push button or plunger-type operator 3010 is moved (by being depressed toward and into the housing 3020 of the switch as is shown in FIG. 17) by a cam 2500 that is defined by the generally cylindrical formation 2100 of the second hinge component 2000.

As is shown in FIGS. 15 and 16, a flat portion of the cam 2500 permits the plunger-type operator 3010 of the energy harvesting switch 3000 to extend nearly a full one-quarter of an inch from the housing of the switch 3000 when the first and second hinge components 1000, 2000, respectively, are in the closed orientation of the first and second hinge components 1000, 2000, respectively. However, when the first and second hinge components 1000, 2000, respectively, pivot relative to each other about the hinge axis 999 to the open orientation shown in FIG. 17 nw 19, a cylindrical portion of the cam 2500 causes the push button or plunger-type operator to be moved by being depressed toward and into the housing 3010 of the switch 3000, as is shown in FIG. 17.

The “closed orientation” of the first and second hinge components 1000, 2000 shown in FIGS. 13-16 also depicts a “closed orientation” of the gate 2040 that is shown in FIG. 18. The “open orientation” of the first and second hinge components 1000, 2000 shown in FIG. 17 also depicts an “open orientation” of the gate 2040 that is shown in FIG. 19.

As can be seen in FIG. 12, the first hinge component 1000 defines a substantially vertically extending, generally cylindrical passage 1012, into which a generally cylindrical formation 2012 of the second hinge component 2000 depends. A substantially flat, upwardly-facing surface 1014 of the first hinge component 1000 is engaged by a substantially flat, downwardly-facing surface 2014 of the second hinge component 2000, to limit how far the generally cylindrical formation 2012 can depend into the generally cylindrical passage 1012 of the first hinge component 1000.

The engagement of the substantially flat surfaces 1014, 2014 not only serves to transfer the weight of the second hinge component 2000 to the first hinge component 1000, but also serves to transfer at least some of the weight of a gate 2040 that is shown as being connected to the second hinge component 2000.

Referring again to FIG. 12, the first hinge component 1000 not only defines the generally cylindrical passage 1012, but also defines a generally rectangular passage 3300 that receives a majority of the housing 3020 of the energy harvesting switch 3000.

When the housing 3020 of the energy harvesting switch 3000 is inserted into the generally rectangular passage 3300 of the first hinge component 1000, a spot of glue or other adhesive (not shown) may be applied to the housing 3020 to assist in retaining the energy harvesting switch 3000 at a desired location within the passage 3300. Alternatively, the passage 3300 can be configured to receive the housing 3020 of the switch 3000 in a press-fit to frictionally retain the housing 3020 of the switch 3000 in the passage 3300.

Inasmuch as the hinge 900 depicted in the drawings hereof is presently comprised of plastics material, the gate 2040 shown in FIGS. 18 and 19 as being fastened to and carried by the hinge 900 is preferably a relatively lightweight element, preferably not exceeding about twenty to twenty-five pounds, so as to not overtax the carrying capacity of the first and second hinge components 1000, 2000. If, instead of forming the hinge components 1000, 2000 from plastics material, the hinge components 1000, 2000 are formed as machined components of metal such as zinc or steel, the gate 2040 fastened to and carried by the second hinge component 2000 can obviously weigh more than only 20 to 25 pounds.

Whereas FIGS. 12-19 depict only one hinge 900 being used to pivotally attach the gate 2040 to the upright support 1040, more than one hinge (not shown) can, of course, be used to supplement the carrying capacity of the one depicted hinge 900.

Although the invention has been described in its preferred form with a certain degree of particularity, it is understood that the present disclosure of the preferred form has been made only by way of example, and that numerous changes in the details of construction and the combination and arrangement of parts may be resorted to without departing from the spirit and scope of the invention. It is intended that such claims as may be presented in a subsequently filed utility patent application will protect whatever features of patentable novelty exist in the invention disclosed.

What is claimed is:

1. A safety device comprising a barrier having a portion that is movable between open and closed orientations, that is biased toward the closed orientation, that when in the closed orientation extends across a secondary travel path near a juncture of the secondary travel path with a primary travel path, that serves to slow the exit of a person and/or a vehicle from the secondary travel path into the juncture when the person and/or vehicle begins to cause movement of the movable portion of the barrier away from the closed orientation toward the open orientation, with the safety device also including means for wirelessly transmitting a radio signal in response to initial movement of the movable portion of the barrier away from the closed orientation toward the open orientation, with the transmitted signal serving to advise another person or vehicle moving along the primary travel path toward the juncture that an individual and/or a vehicle is likely to soon enter the primary travel path at the juncture.

2. The safety device of claim 1 wherein the means for wirelessly transmitting the signal comprises a kinetic energy switch that is operated in response to the initial movement of the movable portion of the barrier away from the closed orientation toward the open orientation.

3. The safety device of claim 2 wherein the wirelessly transmitted signal is a radio frequency signal that operates a warning device to provide an audible or visual alarm to the another person or vehicle.

4. The safety device of claim 2 wherein the kinetic energy switch has a push button or plunger-type operator that is movable relative to a housing of the switch when the switch is operated in response to said initial movement.

5. The safety device of claim 4 wherein the kinetic energy switch harvests at least a portion of the energy of the movement of the plunger to power the wireless transmission of the signal.

6. The safety device of claim 1 wherein the movable barrier is a pivotally mounted gate that can be turned between a gate-closed orientation, and a gate-open orientation, and with the gate being biased toward the gate-closed orientation.

7. The safety device of claim 6 wherein the gate is gravity-biased toward the gate-closed orientation.

8. The safety device of claim 1 wherein the movable barrier is connected to an upstanding support structure that is attachable to a floor surface adjacent the juncture.

9. The safety device of claim 8 wherein the movable barrier has one end region that is connected to the upstanding support structure, and another end region that is movable relative to the upstanding support structure between the open and closed orientations.

10. The safety device of claim 9 wherein the means for wirelessly transmitting the signal comprises a kinetic energy switch that is operated in response to initial movement of the another end region away from the open orientation toward the closed orientation.

11. In combination, a pivotally mounted gate that is movable between an open orientation and a closed orientation, and a kinetic energy switch operably connected to the gate to transmit a radio frequency signal that can be received by a warning device to provide a visual or audible signal when the gate is initially moved away from the closed orientation toward the open orientation.

12. The combination of claim 11 additionally including a warning device capable of receiving a radio signal transmitted by the kinetic energy switch, and capable of providing a visual or audible signal that the gate has been moved away from the closed orientation toward the open orientation.

13. The combination of claim 11 additionally including a kinetic energy switch, and means coupling the kinetic energy switch to the gate for causing the kinetic energy switch to transmit the radio frequency signal when the gate is initially moved away from the closed orientation toward the open orientation.

14. The combination of claim 13 wherein the means coupling the kinetic energy switch to the gate includes a cam that is turned by movement of the gate between the closed and open orientations, with the cam being operable to move a plunger of the kinetic energy switch.

15. The combination of claim 14 wherein the kinetic energy switch is operable to harvest at least some of the energy of the plunger, when moved, to power transmission of the radio frequency signal.

16. In combination, a) an upstanding structure, b) a gate supported by the upstanding structure for pivotal movement relative to the upstanding structure between an open orientation and a closed orientation, c) a kinetic energy switch carried by the upstanding structure, d) with the kinetic energy switch having a housing connected to the upstanding structure, and a plunger that is movable relative to the housing between extended and retracted positions, e) with the kinetic energy switch being operable to transmit a radio signal in response to a certain movement of the plunger relative to the housing, and f) means carried by the gate for causing the certain movement of the plunger in response to initial movement of the gate away from the closed orientation toward the open orientation.

17. The combination of claim 16 additionally including a device capable of receiving and responding to the radio signal to provide either or both of an audible alarm or a visual alarm that advises that the gate being moved away from the closed orientation toward the open orientation.

18. The combination of claim 16 wherein the certain movement of the plunger is a depression of the plunger toward the housing of the kinetic energy switch.

19. The combination of claim 18 wherein the means carried by the gate is a cam that is turned concurrently with pivotal movement of the gate, with the cam being operable to depress the plunger in response to initial pivoting of the gate away from the closed orientation toward the open orientation.

20. In combination, a gate supported by an upstanding structure for pivotal movement between a normal blocking orientation extending across a secondary travel path to block a person and/or a vehicle from exiting the secondary travel path, and an open orientation wherein the gate permits the person and/or vehicle to exit from the secondary travel path onto a primary travel path, AND a kinetic energy switch operably connected to the gate for wirelessly transmitting a radio signal in response to pivotal movement of the gate away from the normal blocking orientation toward the open orientation by the person and/or vehicle exiting the secondary travel path onto the primary travel path.

21. The combination of claim 20 additionally including a warning device capable of receiving and responding to the radio signal from the kinetic energy switch to provide a visual and/or an audible signal to another person and/or vehicle traveling along the primary travel path that a person and/or vehicle is exiting from the secondary travel path onto the primary travel path.
